(19) United States
(12) Patent Application Publication
(10) Pub. No.: US 2007/0284296 A1
(43) Pub. Date: Dec. 13, 2007

(54) Filter cartridge and head assembly with internal shutoff valve

(75) Inventors: David Swain, Palm Harbor, FL (US); Edward C. Giordano, Fort Collins, CO (US)

Correspondence Address: GREER, BURNS & CRAIN, 300 S WACKER DR, 25TH FLOOR, CHICAGO, IL, 60606, US

(73) Assignee: PARAGON WATER SYSTEMS

(21) Appl. No.: 11/449,335

(22) Filed: Jun. 8, 2006

(51) Int. Cl. B01D 35/153

(52) U.S. Cl. 210/235

(57) ABSTRACT

A filter assembly includes a head housing having a water inlet and a water outlet, and a valve disposed in the housing and defining inlet and outlet passageways, and having a first key formation. A cartridge is provided having separate inlet and outlet ports each engageable in a corresponding one of the passageways, and a complementary key formation for engaging the first key formation for ensuring proper engagement of the ports in the passageways. The valve is rotatable in the housing between an open position in which feed water passes through the inlet passageway and into the cartridge, and treated water flows to the outlet passageway, and a closed position in which water is prevented from flowing to and from the valve. The inlet and outlet passageways and the first key formation are generally linearly aligned.

### BACKGROUND OF THE INVENTION

The present invention relates generally to water filtration systems for filtering water in a domestic or commercial embodiment. Such systems are typically connected to a water supply line, and provide filtering of incoming tap water for enhancing taste, mineral content and/or smell characteristics, among other target contaminants. More specifically, the present invention relates to such filter systems having a filter head connected to a water supply line, employing replaceable filter cartridges, and having an automatic shutoff of the supply line while the filter cartridge is being replaced.

In one group of conventional filter systems, exemplified by U.S. Pat. No. 3,746,171, a manually operable water shutoff valve on the filter head must be actuated prior to replacement of the filter cartridge. A disadvantage of such systems is that two hands are required by the installer for exchanging a cartridge. One hand actuates the valve and the other manipulates the cartridge. This procedure is often awkward, in that the location of such filter cartridges is often in hard to reach locations, such as under a sink or basin, or in a utility room.

More recent developments in this field involve the use of spring-loaded valves, exemplified by U.S. Pat. Nos. 5,336,406 and 5,753,107, which include a filter head with an internal, spring-biased valve. The valve is biased to a closed position and is opened only upon satisfactory insertion of a new filter cartridge in a seated, sealed position. These systems provide the advantage of one-handed operation, but have the potential to suffer from spring corrosion and/or failure, and other ancillary manufacturing and/or maintenance issues involved in the inclusion of additional parts and components.

Other conventional filter systems, as disclosed in U.S. Pat. No. 5,826,854 include a rotatable valve located within the head which is actuated by insertion and rotation of the cartridge from an insertion position to an operational position. Such systems have experienced design considerations regarding the handling of residual water in the head after the supply valve has been closed and proper alignment of the cartridge into the head to provide desired fluid communication between the cartridge and the head.

Thus, there is a need for a relatively simple filter cartridge and head assembly which provides the advantage of one-handed cartridge replacement, while minimizing the disadvantages of prior art systems described above.

### BRIEF SUMMARY OF THE INVENTION

The above-identified need is met or exceeded by the present filter assembly, which features few internal parts, and provides for one-handed cartridge replacement. The flow of source water into the cartridge is controlled by rotating the cartridge relative to the head housing, which changes the position of a valve member internally located within the head housing. In a cartridge release position, source water flow into the head assembly is prevented from reaching the cartridge, permitting cartridge replacement. Also, water in outlet passages between the head housing and the faucet is prevented from flowing back to the head housing and onto the user's floor or cabinet. A key system on the cartridge and head provides complementary formations that ensure proper alignment of inlet and outlet ports. The head is also provided with locking platforms for lockingly receiving radially projecting locking lugs on the cartridge. Rotation of the cartridge from the open or flow position to the closed or no-flow position also releases the engagement of the locking lugs with the head housing.

More specifically, a filter cartridge and head assembly includes a head housing having a water inlet and a water outlet, and a valve disposed in the housing, defining inlet and outlet passageways and having a first key formation. A cartridge is provided having inlet and outlet ports, each engageable in a corresponding one of the passageways, and a complementary key formation for engaging the first key formation for ensuring proper engagement of the ports in the passageways. The valve is rotatable in the housing between an open position in which feed water passes through the inlet passageway and into the cartridge, and treated water flows to the outlet passageway, and a closed position in which water is prevented from flowing to and from the valve. The inlet and outlet passageways and the first key formation are generally linearly aligned.

In another embodiment, a filter cartridge is provided for use in a filter assembly including a head housing having a water inlet and a water outlet, a valve rotatably disposed in the housing and defining inlet and outlet passageways respectively in fluid communication with the inlet and outlet, and a first key formation being generally linearly aligned with the inlet and outlet passageways, the valve being rotatable within the head housing between an open position permitting water flow into the inlet passageway from the inlet and a closed position in which water is prevented from flowing into the inlet passageway and backwards from the housing outlet. The filter cartridge includes an inlet port, an outlet port and a complementary key formation being disposed for respective mating engagement in the inlet and outlet passageways and receiving the first key formation, the ports and the complementary key formation being in general linear alignment with each other so that insertion of the cartridge into the valve body and rotation with the valve body relative to the head housing selectively places at least the inlet port into and out of communication with the water inlet.

In yet another embodiment, a head housing is provided for use in a filter assembly including the housing and a filter cartridge having an inlet port, an outlet port and a complementary key formation being disposed for respective mating engagement in the housing and engaging a mating formation in the head housing, the cartridge ports and the recess being in general linear alignment with each other so that insertion of the cartridge into the housing and rotation relative to the head housing will selectively place at least the inlet port into and out of communication with a water inlet. The head housing includes a water inlet and a water outlet, and defines a valve cavity. A valve defines inlet and outlet passageways, has a first key formation, the inlet and outlet passageways and the first key formation being generally linearly aligned. The valve is rotatable in the valve cavity between an open position in which feed water passes into the inlet passage and into the cartridge, and treated water flows to the water outlet, and a the valve being rotatable within the head housing between an open position permitting water flow into the inlet passageway from the inlet and a closed position in which water is prevented from flowing into the inlet passageway and backwards from the housing outlet. A valve cap is securable to the head housing for rotatably retaining the valve in the cavity.

### BRIEF DESCRIPTION OF THE SEVERAL VIEWS OF THE DRAWINGS

FIG. 1 is an exploded perspective view of the present filter cartridge and head assembly;

FIG. 2 is a bottom plan view of the assembled head housing showing the valve in an open position;

FIG. 3 is a cross-section taken along the line 3-3 of FIG. 2 and in the direction generally indicated;

FIG. 4 is a bottom plan view of the assembled head housing showing the valve in a closed position; and

FIG. 5 is a cross-section taken along the line 5-5 of FIG. 4 and in the direction generally indicated.

### DETAILED DESCRIPTION OF THE INVENTION

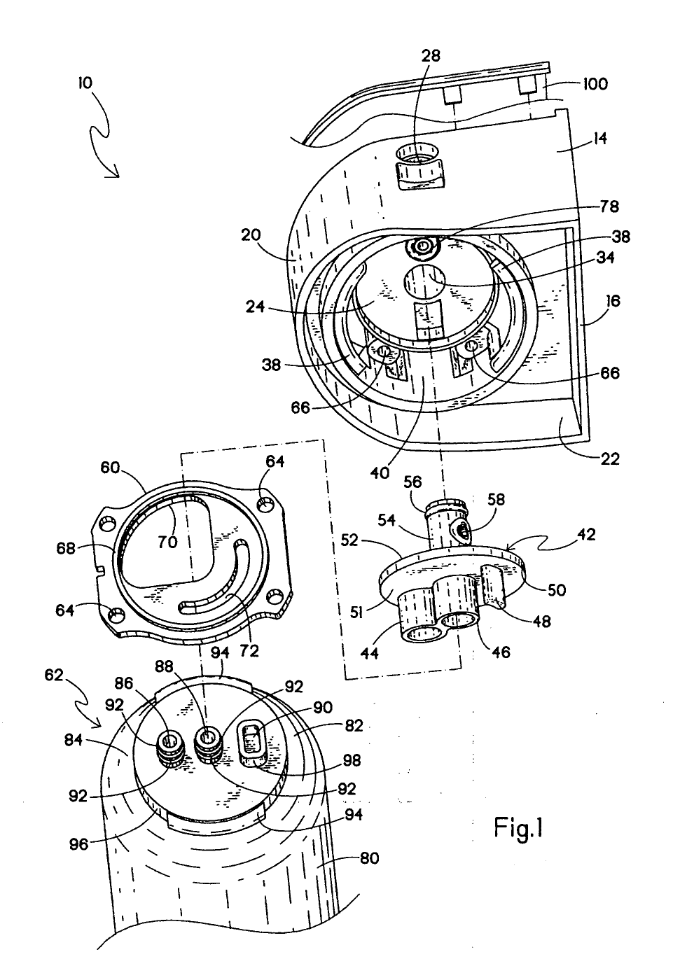

Referring now to FIGS. 1-3, a filter cartridge and head assembly is generally designated 10 and is intended for use in filtering water from a supply line 12 (FIG. 3), such as a tap water line, or the like. As is known in the art, the filter assembly 10 is installed for enhancing taste characteristics, removing odors, bacteria, other organisms or other contaminants as are well known in the art. Also, as is known, such assemblies may be used singly or in groups in fluid communication with each other. The present filter assembly 10 is configured for mounting to a wall, under a sink or other similar location where water supply lines are found in residences or commercial installations such as restaurants, coffee shops, taverns or the like.

Included in the assembly 10 is a head housing 14 configured for mounting to a wall by having a flat rear wall 16 with at least one fastener eyelet 18. Contiguous with the rear wall 16 is a preferably generally curved outer wall 20 which defines an inner cavity 22. The inner cavity 22 is defined at an upper end by a generally horizontally oriented divider or manifold 24 which includes an inlet 26, connected to the supply line 12, and an outlet 28 connected to an outlet line 30 in fluid communication with the end user's access to treated water, such as a faucet, a spigot or the like. As is known in the art, both the inlet 26 and the outlet 28 are provided with quick-connect sealed fittings 32 for facilitating connection to the supply and treated water lines 12, 30.

Also in communication with the inner cavity 22 is an axial bore 34 having an opening 36 in communication with the treated water outlet 28. Axially displaced from the bore 32 are found a pair of spaced, preferably diametrically opposed locking platforms 38. The platforms 38 are preferably placed radially inwardly from the curved outer wall 20, however other configurations are contemplated.

Referring now to FIGS. 1-5, the head housing 14, and specifically the manifold 24 defines a valve cavity 40 into which a valve 42 is rotatably disposed. Included on the valve 42 is an inlet passageway 44, an outlet passageway 46 and a first key formation 48. In the preferred embodiment, both of the passageways 44, 46 are cylindrical and depend generally vertically from a generally disk-shaped divider 50. The first key formation 48 also generally vertically depends from a lower surface 51 of the divider 50. It is also preferred that the outlet passageway 46 is axially located on the divider 50 and defines an axis of rotation of the valve 42 in the head housing 14. As will be described below, both the passageways 44, 46 are in fluid communication with sides of the divider 50 opposite from which they depend.

An important feature of the present assembly 10 is that the inlet and outlet passageways 44, 46 and the first key formation 48 are generally linearly aligned, with the inlet passageway and the first key formation on opposite sides of the outlet passageway; however in some applications the inlet passageway may serve as the central component and define the axis of rotation. In the preferred embodiment, the passageways 44, 46 and the first key formation 48 define a straight line which bisects the divider 50, however other configurations are contemplated depending on the application.

Projecting vertically from an upper surface 52 of the divider 50 is a generally cylindrical outlet portion 54 in fluid communication with the outlet passageway 46, includes annular seals 56 such as O-rings, which sandwich an outlet aperture 58 therebetween (FIGS. 1 and 3). As will be described below, upon insertion of the valve 42 into the valve cavity 40, the outlet aperture 58 is in periodic fluid communication with the outlet 28 depending on the position of the valve. The seals 56 are provided for separating source water entering the inlet passageway 44 from treated water passing through at least one of the outlet aperture 58 and the valve cavity 40.

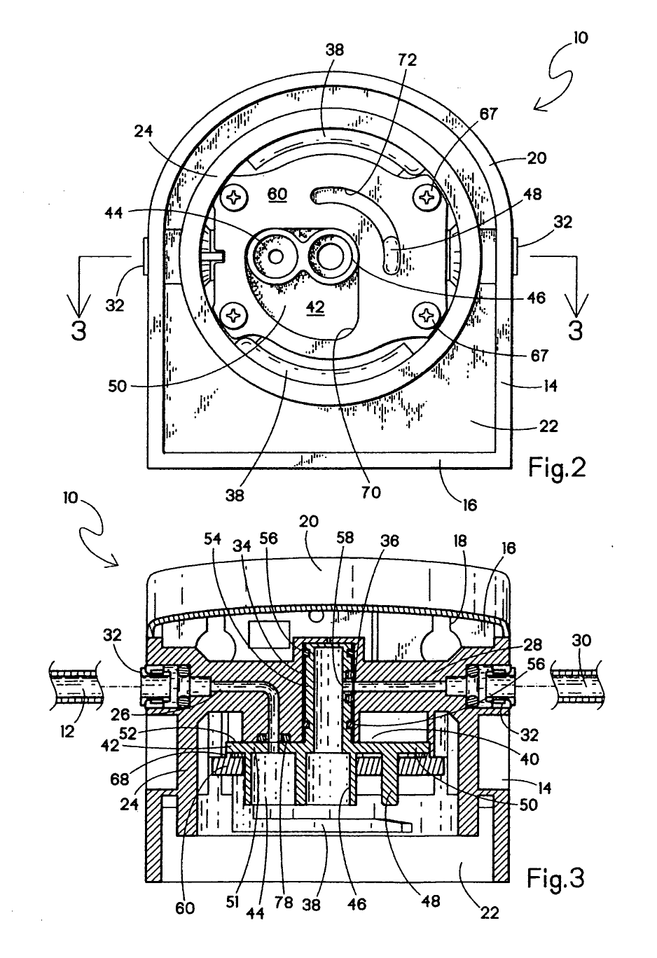

Referring now to FIGS. 1 and 2, a valve cap 60 is provided for retaining the valve 42 in the valve cavity 40. Further, the valve cap 60 is configured for accommodating rotation of the valve 42 in the head housing 14, and specifically in the valve cavity 40, between an open position in which feed water passes through the inlet passageway 44 and into a cartridge 62, and treated water flows to said outlet passageway 46, and a closed position in which water is prevented from flowing from the cartridge, and is also prevented from flowing into the inlet passageway 44 and backwards from the housing outlet 28. Rotation of the valve 42 is about the axis defined by the outlet passageway 46.

Referring now to FIGS. 1, 2 and 4, more specifically, the valve cap 60 is generally planar and is provided with a plurality of mounting eyelets 64 preferably peripherally located for securing the cap to corresponding bores 66 in the head housing 14. While threaded fasteners 67 are preferably used for securing the valve cap 60 in place, other suitable fasteners are contemplated. Also included on the valve cap 60 is an annular, vertically projecting locator ring 68 for properly positioning the cap in the housing 14.

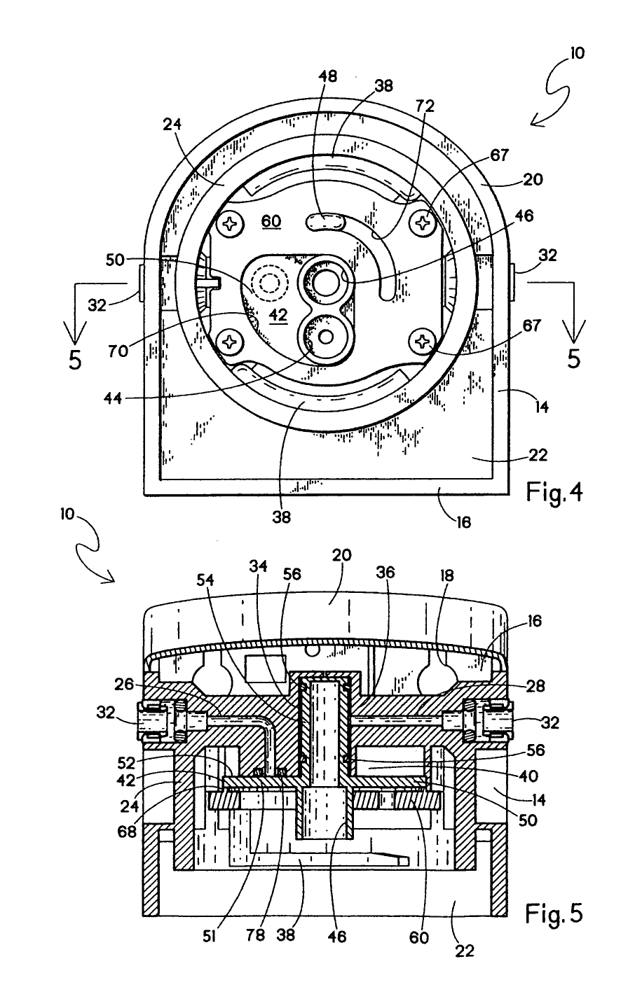

Within the ring 68 are defined two openings, the first being a generally triangular-shaped passageway opening 70 configured for accommodating the rotation of the inlet and outlet passageways 44, 46 during movement between the open position (FIG. 2) and the closed position (FIG. 4). The second opening is a key opening 72 having an arcuate shape for accommodating movement of the first key formation 48 between the open and closed positions.

Referring now to FIGS. 3 and 5, upon assembly of the valve 42 into the valve cavity, and the valve cap 60 to the head housing 14, the divider 50 is rotatably engaged against a surface 74 on the housing, and an inlet aperture 76 on the divider in fluid communication with the inlet passageway 44 is sealed against leakage from the inlet 26 by an annular washer-type seal 78. The seal 78 also prevents leakage from the inlet when the valve 42 is in the closed position and flow from the inlet to the cartridge 62 is prevented. Also, it will be seen that in the assembled condition, the valve cap 60 is vertically displaced from the locking platforms 38.

Referring again to FIG. 1, the cartridge 62 is shown fragmentarily, and includes a main body portion 80, which is enclosed and contains a suitable filter element (not shown), such as activated carbon and suitable septums, hollow fibers, carbon block, nanofiltration membranes, RO technology or other types of filter media used in such systems and being well known in the art. A cartridge closure 82 is located at an upper end 84 and includes a cartridge inlet port 86, a cartridge outlet port 88, each engageable in a corresponding one of the inlet and outlet passageways 44, 46. Also included on the closure 82 is a complementary key formation 90 for engaging the first key formation 48 for ensuring proper alignment and engagement of the ports 86, 88 in the passageways 44, 46. To prevent leakage, each of the ports 86, 88 is provided with at least one and preferably two radial seals 92 such as O-rings as are known in the art. An advantage of placing the seals 92 on the cartridge ports 86, 88 is that they are more frequently replaced during cartridge replacement than they would be if located in the head housing 14.

Also included on the cartridge closure 82 is at least one and preferably a pair of radially extending locking lugs 94, which engage the locking platforms 38 in a well-known bayonet-type push-and-twist operation to securely retain the cartridge physically in the head housing 14, and also to maintain the designated fluid communication between the cartridge ports 86, 88 and the respective passageways 44, 46. The locking lugs 94 are disposed in relation to the cartridge ports 86, 88 so that when the lugs are not in engagement with the platforms 38, allowing release of the cartridge, the valve 42 is moved to the closed position (FIG. 4). Thus, the cartridge 62 may be removed without fear of leakage.

It will be seen from FIG. 1 that the locking lugs 94 are located on a cylindrical extension 96 of the cartridge closure 82. The extension separates the locking lugs 94 from the cartridge inlet and outlet ports 86, 88 and the complementary key formation 90.

To maintain proper alignment between the cartridge ports 86, 88 and the valve inlet and outlet passageways 44, 46, the complementary key formation 90 matingly engages the first key formation 48. In the preferred embodiment, the first key formation 48 is a lug, and the complementary key formation 90 is a recess configured for accommodating at least a portion of the lug. The key formation 90 includes a wall 98 projecting vertically from the extension 96 to define the recess. As is the case with the passages 44, 46 and the first key formation 48, the ports 86, 88 and the complementary key formation 90 are preferably linearly aligned, with the outlet port 88 preferably axially located. However, also as is the case with the valve 42, the position of the inlet and outlet ports 86, 88 may be reversed, as may be the first key formation 48 and the complementary key formation 90, depending on the application.

In operation, beginning with the assembly 10 in the operational or open position (FIGS. 2 and 3), when it is desired to exchange the cartridge 62, the user axially rotates the cartridge body 80 approximately 90°, or a one-quarter turn. This rotation places the locking lugs 94 out of engagement with the locking platforms 38, and also moves the valve from the open position (FIGS. 2 and 3) to the closed position (FIGS. 4 and 5). In the closed position, the outlet aperture 58 of the outlet portion 54 is removed from fluid communication with the outlet 28, and flow from the cartridge 62 is prevented. Also, the seals 56 prevent any liquid leakage at this location.

Also, the inlet aperture 76 is removed from fluid communication with the inlet 26, cutting off fluid intake into the cartridge 62. Leakage is prevented by the seal 78. Thus, rotation of the cartridge 62 simultaneously affects a shutoff of feed water and also releases the cartridge from the head housing 14 in a single motion without the use of external valves requiring manual actuation. Since water flow to and from the valve 42 has been terminated, the cartridge 62 may be exchanged without extra water leaking onto a user's floor or cabinet. In the event maintenance operations are required, or adjustments to the mounting of the head housing 14 to the wall are required, a detachable upper access lid 100 is provided for the housing, and is fastenable to the housing using clips, a friction fit or fasteners as is well known in the art.

While specific embodiments of the filter cartridge and head assembly with internal shutoff valve of the present invention have been shown and described, it will be appreciated by those skilled in the art that changes and modifications may be made thereto without departing from the invention in its broader aspects and as set forth in the following claims.

What is claimed is:

1. A filter cartridge and head assembly, comprising:
a head housing having a water inlet and a water outlet;
a valve disposed in said housing and defining inlet and outlet passageways, and having a first key formation;
a cartridge having separate inlet and outlet ports each engageable in a corresponding one of said passageways, and a complementary key formation for engaging said first key formation for ensuring proper engagement of said ports in said passageways;
said valve being rotatable in said housing between an open position in which feed water passes through said inlet passageway and into said cartridge, and treated water flows to said outlet passageway, and a closed position in which water is prevented from flowing to and from said valve;
said inlet and outlet passageways and said first key formation being generally linearly aligned.

2. The filter assembly of claim 1 in which said first key formation generally vertically depends from said valve.

3. The filter assembly of claim 1 wherein said head housing defines a valve cavity, and said assembly further includes a valve cap securable to said head housing for rotatably retaining said valve in said cavity.

4. The filter assembly of claim 1 wherein said head housing defines a valve cavity configured for matingly and rotatably receiving a generally vertically projecting outlet portion of said valve.

5. The filter assembly of claim 4 further including seal means on said vertically projecting outlet portion for separating source water entering said inlet from treated water passing through at least one of said outlet port and said valve cavity.

6. The filter assembly of claim 1 wherein said valve includes a vertically projecting outlet portion, a generally disk-shaped divider radially projecting from said outlet portion, said first key formation and said outlet passageway depend from said divider.

7. The filter assembly of claim 6 wherein said divider is rotatably engaged against a surface on said head housing, and a seal is provided for sealing said inlet against said divider.

8. The filter assembly of claim 1 wherein said cartridge has a pair of radially extending locking lugs, and said head housing defines a pair of spaced, radially inwardly projecting locking platforms for engaging said locking lugs for physically retaining said cartridge to said head housing.

9. The filter assembly of claim 8 further including a valve cap securable to said head housing for rotatably retaining said valve in said cavity, said valve cap being mounted within said head housing to be vertically displaced from said locking platforms.

10. The filter assembly of claim 1 where said valve is constructed and arranged so that one of said inlet and outlet passageways is axially positioned, and the other of said inlet and outlet passageways and said key formation are linearly positioned on opposite sides of said axially positioned passageway.

11. The filter assembly of claim 1 wherein said first key formation is a lug, and said complementary key formation is a recess configured for matingly engaging at least a portion of said lug.

12. A filter cartridge for use in a filter assembly including a head housing having a water inlet and a water outlet, a valve rotatably disposed in the housing and defining inlet and outlet passageways respectively in fluid communication with the inlet and outlet, and a first key formation being generally linearly aligned with the inlet and outlet passageways, the valve being rotatable within the head housing between an open position permitting water flow into the inlet passageway from the inlet and a closed position in which water is prevented from flowing into the inlet passageway and backwards from the housing outlet, comprising:
an inlet port, an outlet port and a complementary key formation being disposed for respective mating engagement in the inlet and outlet passageways and receiving the first key formation, said ports and said recess being in general linear alignment with each other so that insertion of said cartridge into the valve body and rotation with the valve body relative to the head housing will selectively place at least said inlet port into and out of communication with the water inlet.

13. The cartridge of claim 12 wherein said inlet port and said outlet port are adjacent each other and project vertically from a first end of said cartridge.

14. The cartridge of claim 12 further including at least one locking lug radially projecting from said first end of said cartridge.

15. The cartridge of claim 14 further including a generally cylindrical extension projecting from said first end and separating said at least one locking lug from said inlet and outlet ports and said complementary key formation.

16. The cartridge of claim 14 wherein said complementary key formation is a recess including a wall projecting vertically from said cylindrical extension.

17. The cartridge of claim 12 wherein one of said inlet and outlet passageways is axially positioned, and the other of said inlet and outlet passageways and said complementary key formation are linearly positioned on opposite sides of said axially positioned passageway.

18. A head housing for use in a filter assembly including said housing and a filter cartridge having an inlet port, an outlet port and a complementary key formation being disposed for respective mating engagement in said housing and engaging a mating formation in said head housing, the cartridge ports and the recess being in general linear alignment with each other so that insertion of the cartridge into the housing and rotation relative to the head housing will selectively place at least the inlet port into and out of communication with a water inlet, said housing comprising:
a head housing having a water inlet and a water outlet, and defining a valve cavity;
a valve defining inlet and outlet passageways, having a first key formation, said inlet and outlet passageways and said first key formation being generally linearly aligned;
said valve being rotatable in said housing between an open position in which feed water passes into said inlet passage and into said cartridge, and treated water flows to said water outlet, and a closed position in which water is prevented from flowing into said inlet passageway and backwards from said housing outlet; and
a valve cap securable to said head housing for rotatably retaining said valve in said cavity.
